(19) United States
(12) Patent Application Publication
(10) Pub. No.: US 2022/0204381 A1
(43) Pub. Date: Jun. 30, 2022

(54) COMBINED COLD FORMING AND HOT FORMING PROCESSES FOR INCREASED DESIGN FLEXIBILITY

(71) Applicant: Corning Incorporated, Corning, NY (US)

(72) Inventor: Khaled Layouni, Fontainebleau (FR)

(21) Appl. No.: 17/606,522

(22) PCT Filed: May 1, 2020
(86) PCT No.: PCT/US2020/030906

§ 371 Date: Oct. 26, 2021

Related U.S. Application Data
(60) Provisional application No. 62/842,801, filed on May 3, 2019.

(51) Int. Cl. C03B 23/03; C03C 21/00; B32B 17/10; B60R 13/02

(52) U.S. Cl. CPC C03B 23/0305; C03B 23/0307; B60R 2013/0281; B32B 17/10889; B60R 13/02; C03C 21/002

(57) ABSTRACT

Disclosed herein are embodiments of a method of forming a glass sheet. In the method, a first bend radius is hot-formed in a first region at or above a first temperature. A second bend radius is cold-formed over a second region at a second temperature below the first temperature. The second bend radius is greater than the first bend radius. Also disclosed is a component of a vehicle interior system. The component includes a frame and a glass sheet. The glass sheet has a first curvature with a first bend radius formed by hot-forming. The glass sheet has a second curvature with a second bend radius, less than the first bend radius, formed by cold-forming. The glass sheet is adhered to the frame with an adhesive, and the adhesive is under greater stress in a region of the second curvature than in a region of the first curvature.

### CROSS-REFERENCE TO RELATED APPLICATIONS

This application claims the benefit of priority under 35 U.S.C. § 119 of U.S. Provisional Application Ser. No. 62/842,801 filed on May 3, 2019 the content of which is relied upon and incorporated herein by reference in its entirety.

### BACKGROUND

The disclosure relates to vehicle interior systems including glass and methods for forming the same, and more particularly to vehicle interior systems including a curved glass article that is formed through hot and cold forming techniques.

Vehicle interiors include curved surfaces and can incorporate displays in such curved surfaces. The materials used to form such curved surfaces are typically limited to polymers, which do not exhibit the durability and optical performance as glass. As such, curved glass sheets are desirable, especially when used as covers for displays. Existing methods of forming such curved glass sheets, such as thermal forming, have drawbacks including high cost, optical distortion, and surface marking. Accordingly, Applicant has identified a need for vehicle interior systems that can incorporate a curved glass sheet in a cost-effective manner and without problems typically associated with glass thermal forming processes.

### SUMMARY

According to an aspect, embodiments of the disclosure relate to a method of forming a glass sheet. In the method, a first bend radius is hot-formed in the glass sheet in a first region at or above a first temperature. A second bend radius is cold-formed in the glass sheet over a second region at a second temperature below the first temperature. The second bend radius is greater than the first bend radius.

According to another aspect, embodiments of the disclosure relate to a component of a vehicle interior system. The component includes a frame and a glass sheet. The glass sheet has a first curvature formed by hot-forming and having a first bend radius. The glass sheet has a second curvature formed by cold-forming and having a second bend radius. The first bend radius is less than the second bend radius. The glass sheet is adhered to the frame with an adhesive, and the adhesive is under greater stress in a region of the second curvature than in a region of the first curvature.

According to still another aspect, embodiments of the disclosure relate to a method of forming a vehicle interior system. In the method, a glass sheet is heated in a first region to at least a temperature at which the glass sheet has a viscosity of 10¹² poise (T_{log 12} temperature). The first region is less than the entire glass sheet. The glass sheet is bent while the first region is at least T_{log 12} temperature to form a first curvature having a first bend radius. The glass sheet is adhered to a frame to form a second curvature having a second bend radius. The second curvature is adjacent to the first curvature, and the second bend radius is greater than the first bend radius.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 is a perspective view of a vehicle interior with vehicle interior systems, according to exemplary embodiments;

FIG. 2 depicts a side view of an embodiment of a glass article formed through hot- and cold-forming, according to an exemplary embodiment;

FIG. 3 depicts a side view of another embodiment of a glass article formed through hot- and cold-forming, according to an exemplary embodiment;

FIGS. 4A-4C depict a first method of hot forming a glass sheet, according to an exemplary embodiment;

FIGS. 5A and 5B depict a second method of hot forming a glass sheet, according to an exemplary embodiment;

FIG. 6 is side view of a glass sheet having a thinned region, according to an exemplary embodiment;

FIG. 7 is a perspective view of the glass sheet of FIG. 6, according to an exemplary embodiment;

FIG. 8 is a perspective view of a glass sheet having a series of thinned regions, according to an exemplary embodiment;

FIGS. 9A-9C depict a method of cold-forming a glass sheet, according to an exemplary embodiment; and

FIG. 10 depicts a perspective view of a glass sheet for hot and cold forming, according to an exemplary embodiment.

### DETAILED DESCRIPTION

Reference will now be made in detail to various embodiments, examples of which are illustrated in the accompanying drawings. In general, a vehicle interior system may include a variety of different curved surfaces that are designed to be transparent, such as curved display surfaces and curved non-display glass covers, and the present disclosure provides such curved glass surfaces as well as methods for forming these curved surfaces from a glass material. Forming curved vehicle surfaces from a glass material provide a number of advantages compared to the typical curved plastic panels that are conventionally found in vehicle interiors. For example, glass is typically considered to provide enhanced functionality and user experience in many curved cover material applications, such as display applications and touch screen applications, compared to plastic cover materials.

Accordingly, as will be discussed in more detail below, Applicant has developed a glass article and related manufacturing processes that provide an efficient and cost effective way to form an article, such as a curved glass display and non-display surfaces for a vehicle interior system, utilizing a method involving localized hot forming and global cold forming a glass sheet or glass laminate.

In particular embodiments, the glass sheet or laminate is first hot-formed to introduce sharp curves (i.e., having relatively smaller bend radii) followed by cold-forming to introduce gentler curves (i.e., having relatively larger bend radii). During hot-forming, the glass sheet or laminate is only heated locally in the region or regions where the bending will occur. Thereafter, the glass sheet or glass laminate is cold-formed by attaching the hot-formed glass sheet or glass laminate to a frame with an adhesive. The frame defines the desired curvature of the glass sheet or glass laminate, and the adhesive secures the glass sheet or glass laminate into conformity with the frame. Advantageously, the curved glass article can be made in an economical manner because heating only needs to be performed locally instead of globally over the entire sheet. Previously, a sheet having tight bend radii had to be made entirely through hot-forming, which required heating the entire sheet during forming, which makes such forming a more expensive process. Further, the size of the glass sheet that could be formed was limited by the heating and forming apparatuses. That is, the entire sheet would be heated and formed, meaning that the heating and forming apparatuses had to be able to accommodate the sheet. According to the present disclosure, by first hot forming locally and then globally cold forming, the tight bend radii can still be achieved. Advantageously, the variety of operating designs in widened, including to a larger range of glass thicknesses and sizes of workpieces. Further, precision of the formed part is increased because hot-forming is done locally, and cold-forming involves securing the glass sheet to a precisely shaped frame. Additionally, the process of forming glass sheets using hot and cold forming is less expensive than the process of hot forming the entire sheet.

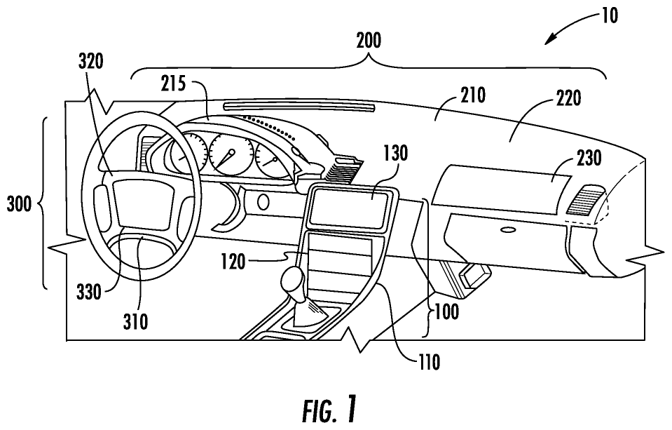

FIG. 1 shows an exemplary vehicle interior 1000 that includes three different embodiments of a vehicle interior system 100, 200, 300. Vehicle interior system 100 includes a frame, shown as center console base 110, with a curved surface 120 including a curved display 130. Vehicle interior system 200 includes a frame, shown as dashboard base 210, with a curved surface 220 including a curved display 230. The dashboard base 210 typically includes an instrument panel 215 which may also include a curved display. Vehicle interior system 300 includes a frame, shown as steering wheel base 310, with a curved surface 320 and a curved display 330. In one or more embodiments, the vehicle interior system includes a frame that is an arm rest, a pillar, pillar-to-pillar, a seat back, a back seat or seats, a floor board, a headrest, a door panel, or any portion of the interior of a vehicle that includes a curved surface. In other embodiments, the frame is a portion of a housing for a free-standing display (i.e., a display that is not permanently connected to a portion of the vehicle).

The embodiments of the curved glass article described herein can be used in each of vehicle interior systems 100, 200 and 300, amongst others. Further, the curved glass articles discussed herein may be used as curved cover glasses for any of the curved display embodiments discussed herein, including for use in vehicle interior systems 100, 200 and/or 300. Further, in various embodiments, various non-display components of vehicle interior systems 100, 200 and 300 may be formed from the glass articles discussed herein. In some such embodiments, the glass articles discussed herein may be used as the non-display cover surface for the dashboard, center console, door panel, etc. In such embodiments, glass material may be selected based on its weight, aesthetic appearance, etc. and may be provided with a coating (e.g., an ink or pigment coating) with a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront functionality.

FIG. 2 depicts an exemplary curved glass article 10 formed via the hot and cold forming method disclosed herein. As can be seen, the curved glass article 10 includes a glass sheet 12 having a first major surface 14 and a second major surface 16. The first major surface 14 is joined to the second major surface 16 by a minor surface 18. The glass sheet 12 is mounted to a frame 20. In particular, the frame 20 has a curved surface 22. The second major surface 16 of the glass sheet 12 substantially conforms to the curved surface 22. The second major surface 16 of the glass sheet 12 is joined to the frame 20, at least in regions, with an adhesive layer 24.

As can be seen in FIG. 2, the glass sheet 12 has at least a first curvature 26 with a tight bend radius that is created using hot forming and at least a second curvature 28 with a greater bend radius that is created using cold forming. In an embodiment, each first curvature 26 has a maximum bend radius of 150 cm. In other embodiments, each first curvature 26 has a maximum bend radius of 100 cm, and in still other embodiments, each first curvature 26 has a maximum bend radius of 50 cm. In embodiments, each second curvature 28 has a minimum bend radius that is greater than bend radius of the first curvature 26. For example, in embodiments, each second curvature 28 has a minimum bend radius of greater than 50 cm, greater than 100 cm, or greater than 150 cm. In embodiments, each second curvature 28 has a maximum bend radius of 5 m. In embodiments, the second curvature 28 has a bend radius of from 50 mm to 5 m.

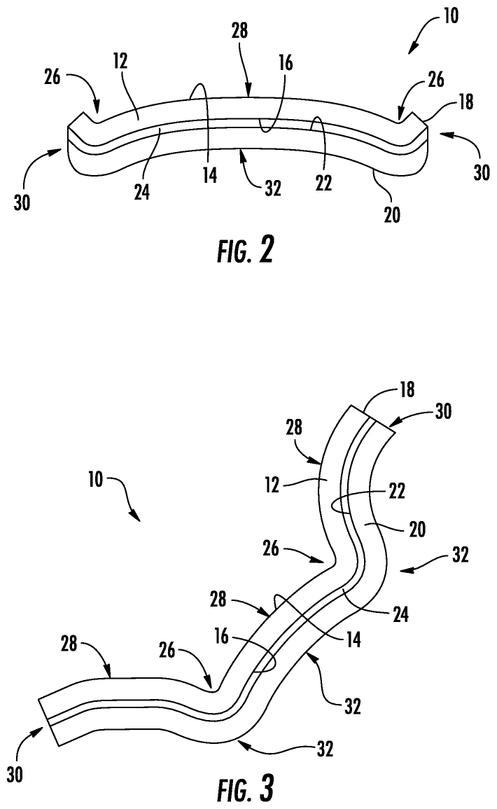

FIG. 3 provides another embodiment of a glass article 10 including a glass sheet 12 attached to a frame 20. As can be seen in a comparison of FIGS. 2 and 3, the first curvatures 26 can be located in any of edge regions 30 or interior regions 32 or both edge regions 30 and interior regions 32. Similarly, the second curvatures 28 can be located in any of edge regions 30 or interior regions 32 or both edge regions 30 and interior regions 32. Further, the shapes of the glass articles 10 depicted in FIGS. 2 and 3 are merely illustrative of the myriad of shapes that can be created using the disclosed hot and cold forming method disclosed herein.

In various embodiments, first major surface 14 and/or the second major surface 16 of glass sheet 12 includes one or more surface treatments or layers. The surface treatment may cover at least a portion of the first major surface 14 and/or second major surface 16. Exemplary surface treatments include anti-glare surfaces/coatings, anti-reflective surfaces/coatings, and an easy-to-clean surface coating/treatment. In one or more embodiments, at least a portion of the first major surface 14 and/or the second major surface 16 may include any one, any two or all three of an anti-glare surface, an anti-reflective surface, and easy-to-clean coating/treatment. For example, first major surface 14 may include an anti-glare surface and second major surface 16 may include an anti-reflective surface. In another example, first major surface 14 includes an anti-reflective surface and second major surface 16 includes an anti-glare surface. In yet another example, the first major surface 14 comprises either one of or both the anti-glare surface and the anti-reflective surface, and the second major surface 16 includes the easy-to-clean coating.

In embodiments, the glass sheet 12 may also include a pigment design on the first major surface 14 and/or second major surface 16. The pigment design may include any aesthetic design formed from a pigment (e.g., ink, paint and the like) and can include a wood-grain design, a brushed metal design, a graphic design, a portrait, or a logo. The pigment design may be printed onto the glass sheet. In one or more embodiments, the anti-glare surface includes an etched surface. In one or more embodiments, the anti-reflective surface includes a multi-layer coating.

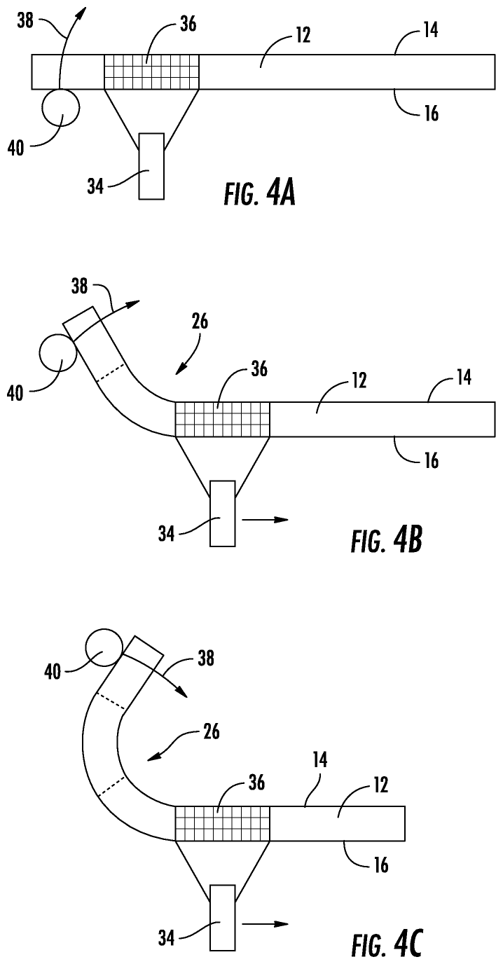

Having described the shape of the glass articles 10, attention is now turned to the method of forming the glass articles 10. The first step in forming the glass articles 10 is hot-forming a glass sheet 12 to produce a first curvature 26. As mentioned above, the hot-forming is performed in such a way that the glass sheet 12 is only heated locally, i.e., in the region where bending occurs. In one embodiment depicted in FIGS. 4A-4C, the glass sheet 12 is heated locally with a local heater 34, such as a laser (e.g., an infrared laser). As shown in FIG. 4A, the local heater 34 creates a heat band 36 in which the temperature of the glass sheet 12 is raised to a temperature at which the viscosity is at least 10¹² poise (referred to as “T_{log 12}”). In embodiments, the local heater 34 raises the temperature of the glass sheet 12 such that viscosity is at least 10¹¹ poise (T_{log 11}), at least 10¹⁰ poise (T_{log 10}), at least 10⁹ poise (T_{log 9}), or at least 10⁸ poise (T_{log 8}). The temperature to achieve a particular viscosity will vary depending on the particular chemistry of the glass composition used to form the glass sheet 12. In embodiments, the temperature in the heat band 36 is in the range of 600° C. to 900° C.

Upon achieving the desired hot-forming temperature in the heat band 36, a bending force 38 as shown in FIG. 4B is applied to the glass sheet 12 so as to bend the glass sheet in the region of the heat band 36. The bending force 38 is applied via an actuation arm 40. Depending on the degree of curvature desired, the local heater 34 may move along the glass sheet 12 such that the heat band 36 travels with the local heater 34. In this way, the first curvature 26 can be made to have a tighter bend radius as shown in FIG. 4C.

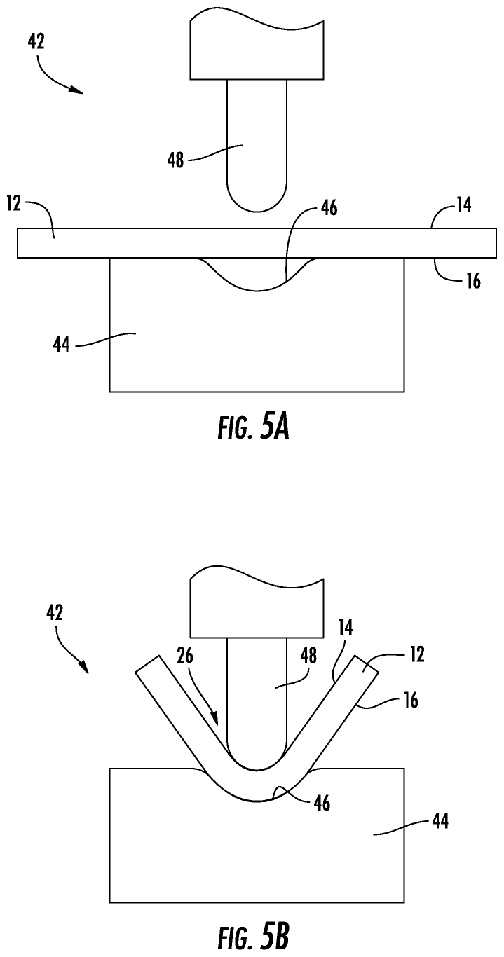

In another embodiment depicted in FIGS. 5A and 5B, the glass sheet 12 is hot-formed in a press 42. As shown in FIG. 5A, the glass sheet 12 is placed on a press form 44 having a surface 46 with the desired curvature. A press ram 48 exerts a bending force on the glass sheet 12 so that the glass sheet 12 conforms to the curvature of the press form 44 as shown in FIG. 5B. In embodiments, the glass sheet 12 may be locally preheated to a temperature in the range of T_{log 12} to T_{log 8}, e.g., using a local heater (such as an infrared laser) as shown in FIG. 4A. Additionally or alternatively, the press form 44 and/or press ram 48 may heat locally heat the glass sheet 12 for forming.

In embodiments, a number of hot-forming operations are performed in sequential steps until the desired number of first curvatures 26 are formed into the glass sheet 12. In other embodiments, all of the first curvatures 26 may be formed in a single hot-forming step, e.g., involving multiple local heaters 34 and/or presses 42.

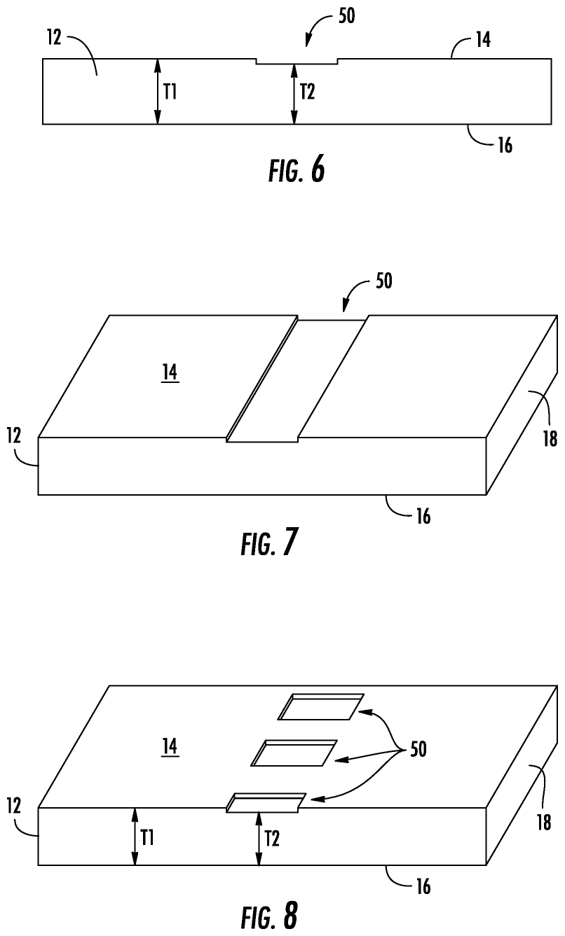

After hot-forming the glass sheet 12, the glass sheet 12 is cold-formed. FIG. 6 depicts an embodiment of a glass sheet 12 that has been locally thinned to facilitate bending during cold-forming. As can be seen, the glass sheet 12 has a first thickness T1 between the first major surface 14 and the second major surface 16, and a second thickness T2 in a thinned region 50. In FIG. 6, the glass sheet 12 is only thinned on the side of the side of the first major surface 14; however, in other embodiments, the glass sheet 12 can be thinned on the sides of both the first major surface 14 and the second major surface 16. FIG. 7 depicts a perspective view of the glass sheet 12 of FIG. 6. As can be seen in FIG. 7, the thinned region 50 extends along the entire length L of the glass sheet 12. However, in other embodiments, such as the embodiment shown in FIG. 8, the first major surface 14 includes a series of thinned regions 50 across the length L of the glass sheet 12. By decreasing the thickness of the glass sheet 12 in the bending region of the first curvature 26, the bending force required to form the first curvature 26 is decreased. In embodiments, the bending force is proportional to T2³, and thus, the glass sheet 12 may be thinned to the degree necessary to achieve a particular bending radius.

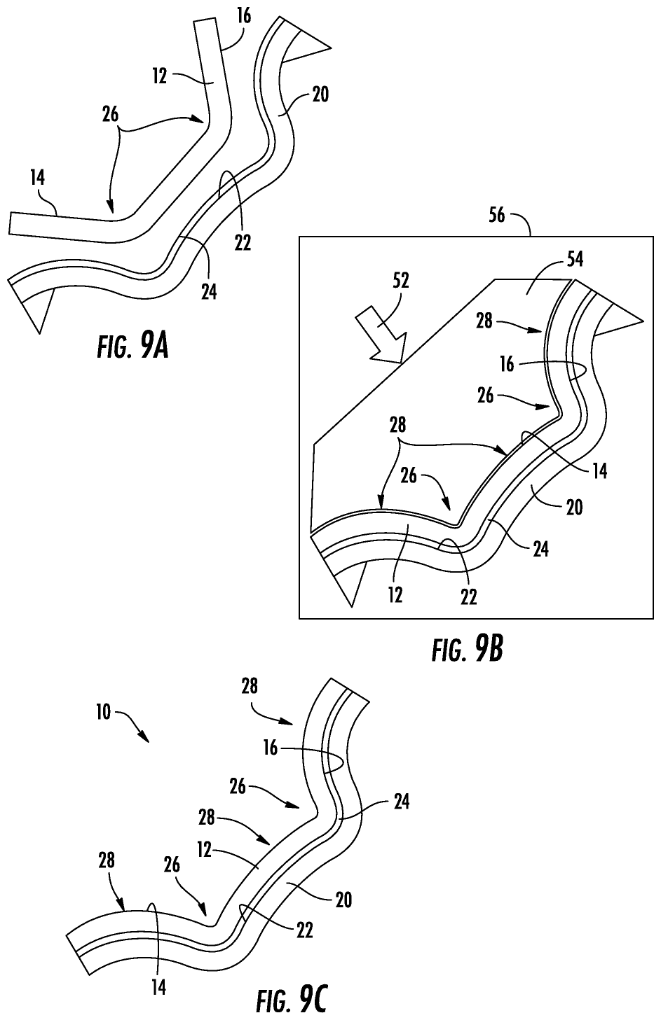

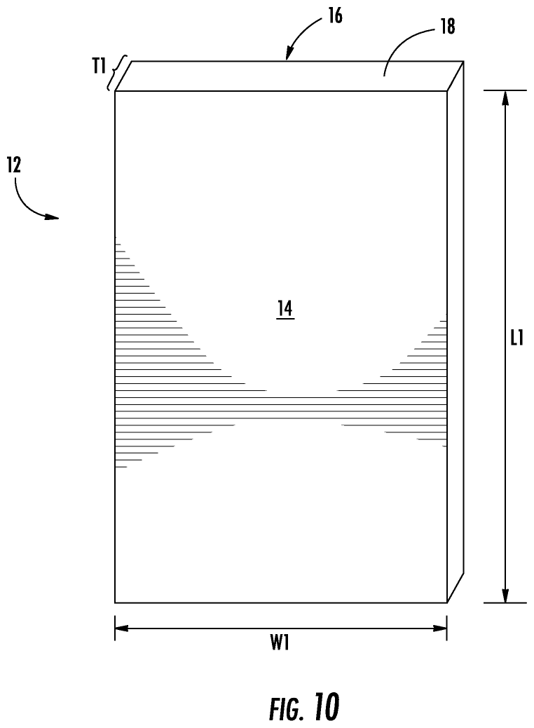

Cold-forming takes place by attaching the glass sheet to a frame 20 as shown in FIGS. 9A-9C. As used herein, the terms “cold-bent,” “cold bending,” “cold-formed,” and “cold forming” each refer to curving the glass sheet at a cold-form temperature which is less than the glass transition temperature of the glass material of glass sheet 12. As shown in FIG. 9A, the glass sheet 12 only has first curvatures 26. As shown in FIG. 9B, a bending force 52 is applied to the glass sheet 12 to bring the glass sheet 12 into conformity with the frame 20, which introduces the second curvatures 28. The adhesive layer 24 holds the glass sheet 12 in conformity with the frame 20, and in embodiments, a press 54 and/or vacuum chamber 56 can be used to keep the glass sheet 12 in conformity with the frame 20 until the adhesive layer 24 cures. In embodiments, curing can be performing using, e.g., one or more of pressure, heat, or ultraviolet radiation, and a variety of adhesives are suitable for use in the adhesive layer 24. Once the adhesive layer 24 cures, the glass article 10 will maintain its cold-formed shape as shown in FIG. 9C.

In embodiments, the adhesive layer 24 may include one or more pressure-sensitive adhesives, such as 3M™ VHB™ (available from 3M, St. Paul, Minn.) and Tesa® (available from tesa SE, Norderstedt, Germany), or UV curable adhesives, such as DELO DUALBOND® MF4992 (available from DELO Industrial Adhesives, Windach, Germany). In embodiments, exemplary adhesives for the adhesive layer include toughened epoxy, flexible epoxy, acrylics, silicones, urethanes, polyurethanes, and silane modified polymers. In specific embodiments, the adhesive layer 24 includes one or more toughened epoxies, such as EP21TDCHT-LO (available from Masterbond®, Hackensack, N.J.), 3M™ Scotch-Weld™ Epoxy DP460 Off-White (available from 3M, St. Paul, Minn.). In other embodiments, the adhesive layer 24 includes one or more flexible epoxies, such as Masterbond EP21TDC-2LO (available from Masterbond®, Hackensack, N.J.), 3M™ Scotch-Weld™ Epoxy 2216 B/A Gray (available from 3M, St. Paul, Minn.), and 3M™ Scotch-Weld™ Epoxy DP125. In still other embodiments, the adhesive layer 24 includes one or more acrylics, such as LORD® Adhesive 410/Accelerator 19 w/LORD® AP 134 primer, LORD® Adhesive 852/LORD® Accelerator 25 GB (both being available from LORD Corporation, Cary, N.C.), DELO PUR SJ9356 (available from DELO Industrial Adhesives, Windach, Germany), Loctite® AA4800, Loctite® HF8000. TEROSON® MS 9399, and TEROSON® MS 647-2C (these latter four being available from Henkel AG & Co. KGaA, Dusseldorf, Germany), among others. In yet other embodiments, the adhesive layer 24 includes one or more urethanes, such as 3M™ Scotch-Weld™ Urethane DP640 Brown and 3M™ Scotch-Weld™ Urethane DP604, and in still further embodiments, the adhesive layer 24 includes one or more silicones, such as Dow Corning® 995 (available from Dow Corning Corporation, Midland, Mich.). In embodiments, the adhesive layer 24 may include at least two of any of the aforementioned adhesives, including pressure-sensitive adhesives, UV curable adhesives, toughened epoxies, flexible epoxies, acrylics, silicones, urethanes, polyurethanes, and silane modified polymers.

As shown in FIG. 9C, the glass article 10 is depicted with a continuous adhesive layer 24 extending across the width of the glass article 10. However, in embodiments, the adhesive layer 24 is only provided in the regions of the second curvatures 28, i.e., where the adhesive layer 24 is necessary to keep the glass sheet 12 in conformity with the frame 20. The regions of the first curvatures 26, having been hot-formed, do not need an adhesive to maintain their curvatures. If adhesive is applied in the regions of the first curvatures 26, the adhesive serves to secure the glass sheet 12 to the frame 20 in that region. In comparison to the first curvatures 26, the adhesive holding down the second curvatures 28 will be under delaminating stress.

FIG. 10 depicts an embodiment of a glass sheet 12 suitable for use in the presently disclosed hot- and cold-forming method. In embodiments, the glass sheet 12 has a thickness T1 (e.g., an average thickness measured between major surfaces 14, 16) that is in a range from 0.15 mm to 2 mm. In specific embodiments, T1 is less than or equal to 1.5 mm and in more specific embodiments, T1 is 0.4 mm to 1.3 mm. Applicant has found that such thin glass sheets can be cold formed to a variety of curved shapes utilizing cold forming without breakage while at the same time providing for a high quality cover layer for a variety of vehicle interior applications. In addition, such thin glass sheets 12 may deform more readily, which could potentially compensate for shape mismatches and gaps that may exist relative to curved surface 22 and/or frame 20.

In various embodiments, glass sheet 12 is formed from a strengthened glass sheet (e.g., a thermally strengthened glass material, a chemically strengthened glass sheet, etc.) In such embodiments, when glass sheet 12 is formed from a strengthened glass material, first major surface 14 and second major surface 16 are under compressive stress, and thus second major surface 16 can experience greater tensile stress during bending to the convex shape without risking fracture. This allows for strengthened glass sheet 12 to conform to more tightly curved surfaces.

A feature of a cold-formed glass sheet is an asymmetric surface compressive between the first major surface 14 and the second major surface 16 once the glass sheet 12 has been bent to the curved shape. In such embodiments, prior to the cold-forming process or being cold-formed, the respective compressive stresses in the first major surface 14 and the second major surface 16 of glass sheet 12 are substantially equal. After cold-forming, the compressive stress in concave regions of the second major surface 16 increases such that the compressive stress on the second major surface 16 is greater after cold-forming than before cold-forming. In contrast, convex regions of the first major surface 14 experience tensile stresses during bending causing a net decrease in surface compressive stress on the first major surface 14, such that the compressive stress in the convex regions of the first major surface 14 following bending is less than the compressive stress in the first major surface 14 when the glass sheet is flat. The opposite is true for the concave regions of the first major surface 14 and for the convex regions of the second major surface 16.

Referring to FIG. 10, additional structural details of glass sheet 12 are shown and described. As noted above, glass sheet 12 has a thickness T1 that is substantially constant and is defined as a distance between the first major surface 14 and the second major surface 16. In various embodiments, T1 may refer to an average thickness or a maximum thickness of the glass sheet. In addition, glass sheet 12 includes a width W1 defined as a first maximum dimension of one of the first or second major surfaces 14, 16 orthogonal to the thickness T1, and a length L1 defined as a second maximum dimension of one of the first or second major surfaces 14, 16 orthogonal to both the thickness and the width. In other embodiments, W1 and L1 may be the average width and the average length of glass sheet 12, respectively.

In various embodiments, thickness T1 is 2 mm or less and specifically is 0.1 mm to 2 mm. For example, thickness T1 may be in a range from about 0.1 mm to about 1.5 mm, from about 0.15 mm to about 1.5 mm, from about 0.2 mm to about 1.5 mm, from about 0.25 mm to about 1.5 mm, from about 0.3 mm to about 1.5 mm, from about 0.35 mm to about 1.5 mm, from about 0.4 mm to about 1.5 mm, from about 0.45 mm to about 1.5 mm, from about 0.5 mm to about 1.5 mm, from about 0.55 mm to about 1.5 mm, from about 0.6 mm to about 1.5 mm, from about 0.65 mm to about 1.5 mm, from about 0.7 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, or from about 0.3 mm to about 0.7 mm. In other embodiments, the T1 falls within any one of the exact numerical ranges set forth in this paragraph.

In various embodiments, width W1 is in a range from 5 cm to 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm. In other embodiments, W1 falls within any one of the exact numerical ranges set forth in this paragraph.

In various embodiments, length L1 is in a range from about 5 cm to about 1500 cm, from about 50 cm to about 1500 cm, from about 100 cm to about 1500 cm, from about 150 cm to about 1500 cm, from about 200 cm to about 1500 cm, from about 250 cm to about 1500 cm, from about 300 cm to about 1500 cm, from about 350 cm to about 1500 cm, from about 400 cm to about 1500 cm, from about 450 cm to about 1500 cm, from about 500 cm to about 1500 cm, from about 550 cm to about 1500 cm, from about 600 cm to about 1500 cm, from about 650 cm to about 1500 cm, from about 650 cm to about 1500 cm, from about 700 cm to about 1500 cm, from about 750 cm to about 1500 cm, from about 800 cm to about 1500 cm, from about 850 cm to about 1500 cm, from about 900 cm to about 1500 cm, from about 950 cm to about 1500 cm, from about 1000 cm to about 1500 cm, from about 1050 cm to about 1500 cm, from about 1100 cm to about 1500 cm, from about 1150 cm to about 1500 cm, from about 1200 cm to about 1500 cm, from about 1250 cm to about 1500 cm, from about 1300 cm to about 1500 cm, from about 1350 cm to about 1500 cm, from about 1400 cm to about 1500 cm, or from about 1450 cm to about 1500 cm. In other embodiments, L1 falls within any one of the exact numerical ranges set forth in this paragraph.

In embodiments, one or more of the glass sheets 12 can be incorporated into a laminate structure. For example, a second glass sheet can be locally hot-formed (e.g., as shown in FIGS. 4A-C and 5A-5B) and then cold-formed with a first glass sheet (essentially, the same steps as FIGS. 9A-9C with a second glass sheet 12 overlaid the first glass sheet 12). The glass sheets 12 may be joined by a polymer binder, such as polyvinyl butyral (PVB) or polycarbonate. Such glass laminates are usable in a variety of contexts, including as a windshield for a vehicle. Further, in embodiments, the laminate structure may be a partial laminate structure in which a glass sheet 12 is only joined in a region to another glass sheet 12. That is, the glass sheets 12 are not co-terminal in at least one of their length or width dimensions. Additionally, in embodiments, the glass sheets 12 of the laminate or partial laminate structure have different thicknesses.

The various embodiments of the vehicle interior system may be incorporated into vehicles such as trains, automobiles (e.g., cars, trucks, buses and the like), sea craft (boats, ships, submarines, and the like), and aircraft (e.g., drones, airplanes, jets, helicopters and the like).

### Strengthened Glass Properties

As noted above, glass sheet 12 may be strengthened. In one or more embodiments, glass sheet 12 may be strengthened to include compressive stress that extends from a surface to a depth of layer (DOL). The compressive stress regions are balanced by a central portion exhibiting a tensile stress. At the DOL, the stress crosses from a positive (compressive) stress to a negative (tensile) stress.

In various embodiments, glass sheet 12 may be strengthened mechanically by utilizing a mismatch of the coefficient of thermal expansion between portions of the article to create a compressive stress region and a central region exhibiting a tensile stress. In some embodiments, the glass sheet may be strengthened thermally by heating the glass to a temperature above the glass transition point and then rapidly quenching.

In various embodiments, glass sheet 12 may be chemically strengthened by ion exchange. In the ion exchange process, ions at or near the surface of the glass sheet are replaced by—or exchanged with—larger ions having the same valence or oxidation state. In those embodiments in which the glass sheet comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass sheet generate a stress.

Ion exchange processes are typically carried out by immersing a glass sheet in a molten salt bath (or two or more molten salt baths) containing the larger ions to be exchanged with the smaller ions in the glass sheet. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass sheet in a salt bath (or baths), use of multiple salt baths, additional steps such as annealing, washing, and the like, are generally determined by the composition of the glass sheet (including the structure of the article and any crystalline phases present) and the desired DOL and CS of the glass sheet that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass sheets may be immersed in a molten salt bath of 100% NaNO₃, 100% KNO₃, or a combination of NaNO₃ and KNO₃ having a temperature from about 370° C. to about 480° C. In some embodiments, the glass sheet may be immersed in a molten mixed salt bath including from about 5% to about 90% KNO₃ and from about 10% to about 95% NaNO₃. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass sheet may be immersed in a molten, mixed salt bath including NaNO₃ and KNO₃ (e.g., 49%61%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass sheet. The spike may result in a greater surface CS value. This spike can be achieved by a single bath or multiple baths, with the bath(s) having a single composition or mixed composition, due to the unique properties of the glass compositions used in the glass sheets described herein.

In one or more embodiments, where more than one monovalent ion is exchanged into the glass sheet, the different monovalent ions may exchange to different depths within the glass sheet (and generate different magnitudes stresses within the glass sheet at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass sheet. In other embodiments, the maximum compressive stress may occur at a depth below the surface, giving the compressive profile the appearance of a “buried peak.”

DOL may be measured by FSM or by a scattered light polariscope (SCALP) (such as the SCALP-04 scattered light polariscope available from Glasstress Ltd., located in Tallinn Estonia), depending on the strengthening method and conditions. When the glass sheet is chemically strengthened by an ion exchange treatment, FSM or SCALP may be used depending on which ion is exchanged into the glass sheet. Where the stress in the glass sheet is generated by exchanging potassium ions into the glass sheet, FSM is used to measure DOL. Where the stress is generated by exchanging sodium ions into the glass sheet, SCALP is used to measure DOL. Where the stress in the glass sheet is generated by exchanging both potassium and sodium ions into the glass, the DOL is measured by SCALP, since it is believed the exchange depth of sodium indicates the DOL and the exchange depth of potassium ions indicates a change in the magnitude of the compressive stress (but not the change in stress from compressive to tensile); the exchange depth of potassium ions in such glass sheets is measured by FSM. Central tension or CT is the maximum tensile stress and is measured by SCALP.

In one or more embodiments, the glass sheet may be strengthened to exhibit a DOL that is described as a fraction of the thickness T1 of the glass sheet (as described herein). For example, in one or more embodiments, the DOL may be equal to or greater than about 0.05T1, equal to or greater than about 0.1T1, equal to or greater than about 0.11T1, equal to or greater than about 0.12T1, equal to or greater than about 0.13T1, equal to or greater than about 0.14T1, equal to or greater than about 0.15T1, equal to or greater than about 0.16T1, equal to or greater than about 0.17T1, equal to or greater than about 0.18T1, equal to or greater than about 0.19T1, equal to or greater than about 0.2T1, equal to or greater than about 0.21T1. In some embodiments, the DOL may be in a range from about 0.08T1 to about 0.25T1, from about 0.09T1 to about 0.25T1, from about 0.18T1 to about 0.25T1, from about 0.11T1 to about 0.25T1, from about 0.12T1 to about 0.25T1, from about 0.13T1 to about 0.25T1, from about 0.14T1 to about 0.25T1, from about 0.15T1 to about 0.25T1, from about 0.08T1 to about 0.24T1, from about 0.08T1 to about 0.23T1, from about 0.08T1 to about 0.22T1, from about 0.08T1 to about 0.21T1, from about 0.08T1 to about 0.2T1, from about 0.08T1 to about 0.19T1, from about 0.08T1 to about 0.18T1, from about 0.08T1 to about 0.17T1, from about 0.08T1 to about 0.16T1, or from about 0.08T1 to about 0.15T1. In some instances, the DOL may be about 20 μm or less. In one or more embodiments, the DOL may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm. In other embodiments, DOL falls within any one of the exact numerical ranges set forth in this paragraph.

In one or more embodiments, the strengthened glass sheet may have a CS (which may be found at the surface or a depth within the glass sheet) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the strengthened glass sheet may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa. In other embodiments, CS falls within the exact numerical ranges set forth in this paragraph.

### Glass Compositions

Suitable glass compositions for use in glass sheet 12 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition includes Al₂O₃ in an amount greater than about 4 mol %, or greater than about 5 mol %. In one or more embodiments, the glass composition includes Al₂O₃ in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass. In this regard, the glass composition or article formed therefrom includes Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ (e.g., about 0.01 mol % or greater). In one or more embodiments, the glass composition comprises a non-zero amount of P₂O₅ up to and including 2 mol %, 1.5 mol %, 1 mol %, or 0.5 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition includes a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition includes Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition includes less than about 4 mol % K₂O, less than about 3 mol % K₂O, or less than about 1 mol % K₂O. In some instances, the glass composition may include K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O.

In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In some embodiments, the glass composition includes a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition includes CaO in an amount less than about 1 mol %, less than about 0.8 mol %, or less than about 0.5 mol %. In one or more embodiments, the glass composition is substantially free of CaO.

In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to (and including) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition includes TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass sheet 12 may be made from any glass composition falling with any one of the exact numerical ranges discussed above.

Aspect (1) of this disclosure pertains to a method of forming a glass sheet, comprising the steps of: hot-forming a first bend radius in the glass sheet in a first region at or above a first temperature; cold-forming a second bend radius in the glass sheet over a second region at a second temperature below the first temperature, the second bend radius being greater than the first bend radius.

Aspect (2) of this disclosure pertains to the method of Aspect (1), wherein the first temperature is at least a temperature at which the glass sheet has a viscosity of 10¹² poise.

Aspect (3) of this disclosure pertains to the method of Aspect (1) or Aspect (2), wherein, during the step of hot-forming, the glass sheet is only at or above the first temperature in the first region and wherein the glass sheet is below the first temperature outside the first region.

Aspect (4) of this disclosure pertains to the method of any one of Aspects (1) through (3), wherein, during the step of cold-forming, the entire glass sheet is at the second temperature which is in a range of from 20° C. to less than a glass transition temperature of the glass sheet.

Aspect (5) of this disclosure pertains to the method of any one of Aspects (1) through (4), wherein the first bend radius at most 150 mm.

Aspect (6) of this disclosure pertains to the method of any one of Aspects (1) through (5), wherein hot-forming comprises at least one of pressing a ram into the first region of the sheet to form the first bend radius or bending the glass sheet after heating the first region using an infrared laser.

Aspect (7) of this disclosure pertains to the method of any one of Aspects (1) through (6), wherein the glass sheet is one of soda lime silicate glass, aluminosilicate glass, alkali aluminosilicate glass, or borosilicate glass.

Aspect (8) of this disclosure pertains to the method of Aspect (7), wherein the glass sheet is chemically strengthened.

Aspect (9) of this disclosure pertains to the method of any one of Aspects (1) through (8), wherein the glass sheet is combined with another glass sheet to form a laminate, wherein the glass sheet and the other glass sheet undergo the step of colding-forming together.

Aspect (10) of this disclosure pertains to the method of any one of Aspects (1) through (9), wherein cold-forming further comprises adhering the glass sheet to a frame such that the glass sheet conforms to a shape of the frame.

Aspect (11) of this disclosure pertains to the method of any one of Aspects (1) through (10), wherein a maximum thickness of the glass sheet measured between a first major surface and a second major surfaces is from 0.15 mm to 2.0 mm.

Aspect (12) of this disclosure pertains to the method of any one of Aspects (1) through (11), wherein the glass sheet has a width and a length, wherein the width is from 1 cm to 50 cm, and the length is from 10 cm to 200 cm.

Aspect (13) of this disclosure pertains to a component of a vehicle interior system, comprising: a frame; and a glass sheet comprising a first curvature formed by hot-forming and having a first bend radius and a second curvature formed by cold-forming and having a second bend radius, wherein the first bend radius is less than the second bend radius; wherein the glass sheet is adhered to the frame with an adhesive; and wherein the adhesive is under greater stress in a region of the second curvature than in a region of the first curvature.

Aspect (14) of this disclosure pertains to the component of Aspect (13), wherein the frame comprises any one of a center console, a dashboard, an instrument panel, an arm rest, a pillar, a seat back, a floor board, a headrest, a door panel, a steering wheel and a portion of a housing of a free-standing display.

Aspect (15) of this disclosure pertains to the component of Aspect (13) or Aspect (14), wherein the vehicle is any one of an automobile, a sea craft, or an aircraft.

Aspect (16) of this disclosure pertains to the component of any one of Aspects (13) through (15), comprising a third curvature formed by hot forming and having a third bend radius, wherein the third bend radius is less than the second bend radius and wherein the second curvature is arranged between the first curvature and the third curvature.

Aspect (17) of this disclosure pertains to the component of Aspect (16), wherein the first curvature and the third curvature are both concave and the second curvature is convex.

Aspect (18) of this disclosure pertains to the component of Aspect (17), further comprising a fourth curvature that is concave, wherein the third curvature is arranged between the second curvature and the fourth curvature.

Aspect (19) of this disclosure pertains to the component of Aspect (16), wherein the first curvature, the second curvature, and the third curvature are all concave.

Aspect (20) of this disclosure pertains to a method of Aspect (20), comprising the steps of: heating a glass sheet in a first region to at least a temperature at which the glass sheet has a viscosity of 10¹² poise (T_{log 12} temperature), the first region being less than the entire glass sheet; bending the glass sheet while the first region is at least T_{log 12} temperature to form a first curvature having a first bend radius; adhering the glass sheet to a frame to form a second curvature having a second bend radius, the second curvature being adjacent to the first curvature, wherein the second bend radius is greater than the first bend radius.

Aspect (21) of this disclosure pertains to the method of Aspect (20), wherein the first bend radius at most 150 mm.

Aspect (22) of this disclosure pertains to the method of Aspect (20) or Aspect (21), wherein the step of bending comprises pressing a ram into the first region to form the first curvature.

Aspect (23) of this disclosure pertains to the method of any one of Aspects (20) through (22), wherein the step of heating comprises irradiating the glass sheet in the first region with a laser.

Aspect (24) of this disclosure pertains to the method of any one of Aspects (20) through (23), wherein the glass sheet is one of soda lime silicate glass, aluminosilicate glass, alkali aluminosilicate glass, or borosilicate glass.

Aspect (25) of this disclosure pertains to the method of Aspect (24), wherein the glass sheet is chemically strengthened.

Aspect (26) of this disclosure pertains to the method of any one of Aspects (20) through (25), wherein a maximum thickness of the glass sheet measured between a first major surface and a second major surfaces is 0.15 mm to 2.0 mm.

Aspect (27) of this disclosure pertains to the method of any one of Aspects (20) through (26), wherein the glass sheet has a width and a length, wherein the width is from 1 cm to 50 cm, and the length is from 10 cm to 200 cm.

Aspect (28) of this disclosure pertains to the method of any one of Aspects (20) through (27), wherein the frame comprises any one of a center console, a dashboard, an instrument panel, an arm rest, a pillar, a seat back, a floor board, a headrest, a door panel, a steering wheel and a portion of a housing of a free-standing display.

Aspect (29) of this disclosure pertains to the method of any one of Aspects (20) through (28), wherein the vehicle is any one of an automobile, a sea craft, or an aircraft.

Aspect (30) of this disclosure pertains to the method of any one of Aspects (20) through (29), wherein the steps of heating and bending produce a third curvature having a third bend radius that is less than the second bend radius, wherein the second curvature is arranged between the first curvature and the third curvature.

Aspect (31) of this disclosure pertains to the method of Aspect (30), wherein the first curvature and the third curvature are both concave and the second curvature is convex.

Aspect (32) of this disclosure pertains to the method of Aspect (31), wherein cold forming further produces a fourth curvature having a fourth bend radius that is greater than the first and third bend radii, wherein the fourth curvature is concave, and wherein the third curvature is arranged between the second curvature and the fourth curvature.

Aspect (33) of this disclosure pertains to the method of Aspect (30), wherein the first curvature, the second curvature, and the third curvature are all concave.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method of forming a glass sheet, comprising the steps of:
hot-forming a first bend radius in the glass sheet in a first region at or above a first temperature;
cold-forming a second bend radius in the glass sheet over a second region at a second temperature below the first temperature, the second bend radius being greater than the first bend radius.

2. The method of claim 1, wherein the first temperature is at least a temperature at which the glass sheet has a viscosity of 10¹² poise.

3. The method of claim 1, wherein, during the step of hot-forming, the glass sheet is only at or above the first temperature in the first region and wherein the glass sheet is below the first temperature outside the first region.

4. The method of claim 1, wherein, during the step of cold-forming, the entire glass sheet is at the second temperature which is in a range of from 20° C. to less than a glass transition temperature of the glass sheet.

5. The method of claim 1, wherein the first bend radius at most 150 mm.

6. The method of claim 1, wherein hot-forming comprises at least one of pressing a ram into the first region of the sheet to form the first bend radius or bending the glass sheet after heating the first region using an infrared laser.

7. The method of claim 1, wherein:
the glass sheet is one of soda lime silicate glass, aluminosilicate glass, alkali aluminosilicate glass, or borosilicate glass, and
the glass sheet is chemically strengthened.

8. (canceled)

9. The method of claim 1, wherein the glass sheet is combined with another glass sheet to form a laminate, wherein the glass sheet and the other glass sheet undergo the step of cold-forming together.

10. The method of claim 1, wherein the cold-forming comprises adhering the glass sheet to a frame such that the glass sheet conforms to a shape of the frame.

11. The method of claim 1, wherein a maximum thickness of the glass sheet measured between a first major surface and a second major surfaces is from 0.15 mm to 2.0 mm.

12. (canceled)

13. A component of a vehicle interior system, comprising:
a frame; and
a glass sheet comprising a first curvature formed by hot-forming and having a first bend radius and a second curvature formed by cold-forming and having a second bend radius, wherein the first bend radius is less than the second bend radius;
wherein the glass sheet is adhered to the frame with an adhesive; and
wherein the adhesive is under greater stress in a region of the second curvature than in a region of the first curvature.

14. The component of claim 13, wherein the frame comprises any one of a center console, a dashboard, an instrument panel, an arm rest, a pillar, a seat back, a floor board, a headrest, a door panel, a steering wheel and a portion of a housing of a free-standing display.

15. (canceled)

16. The component of claim 13, comprising a third curvature formed by hot forming and having a third bend radius, wherein the third bend radius is less than the second bend radius and wherein the second curvature is arranged between the first curvature and the third curvature.

17. The component of claim 16, wherein the first curvature and the third curvature are both concave and the second curvature is convex.

18-19. (canceled)

20. A method of forming a vehicle interior system, comprising the steps of:
heating a glass sheet in a first region to at least a temperature at which the glass sheet has a viscosity of 10¹² poise (T_{log 12} temperature), the first region being less than the entire glass sheet;
bending the glass sheet while the first region is at least the T_{log 12} temperature to form a first curvature having a first bend radius;
adhering the glass sheet to a frame to form a second curvature having a second bend radius, the second curvature being adjacent to the first curvature, wherein the second bend radius is greater than the first bend radius.

21. The method of claim 20, wherein the first bend radius at most 150 mm.

22. The method of claim 20, wherein the step of bending comprises pressing a ram into the first region to form the first curvature.

23. The method of claim 20, wherein the step of heating comprises irradiating the glass sheet in the first region with a laser.

24. The method of claim 20, wherein the glass sheet is one of soda lime silicate glass, aluminosilicate glass, alkali aluminosilicate glass, or borosilicate glass.

25-29. (canceled)

30. The method of claim 20, wherein the steps of heating and bending produce a third curvature having a third bend radius that is less than the second bend radius, wherein the second curvature is arranged between the first curvature and the third curvature.

31-33. (canceled)
